(19) United States
(12) Patent Application Publication
(10) Pub. No.: US 2026/0067512 A1
(43) Pub. Date: Mar. 5, 2026

(54) Duality App

(71) Applicant: StreamWise LLC, Smyrna, GA (US)

(72) Inventor: Ayobami A. Temilovluwa, Smyrna, GA (US)

(21) Appl. No.: 19/097,647

(22) Filed: Apr. 1, 2025

Related U.S. Application Data
(60) Provisional application No. 63/690,694, filed on Sep. 4, 2024.

(51) Int. Cl. H04N 21/2187; H04N 5/073; H04N 21/4788

(52) U.S. Cl. CPC H04N 21/2187; H04N 5/0733; H04N 21/4788

(57) ABSTRACT

An innovative mobile application designed to improve how a user experiences real-time streaming and live chat over their smartphone or mobile device. The mobile application combines live streaming, augmented reality, and real-time interaction. The mobile application is comprised of a dual-camera interface allowing simultaneous streaming from a front camera and a rear camera of a mobile device; an augmented reality feature that detects and overlays digital information on real-world objects observed through a camera of a mobile device; and a live chat feature enabling a real-time interaction during a live video streaming session. Combining dual-camera streaming with live chat offers a powerful tool for content creators, influencers, and professionals who want to engage with their audience in a more interactive and personal way. Whether it's for virtual events, tutorials, or social interaction, the mobile application enhances a user's experience by providing multiple views and real-time communication.

### FIELD OF THE DISCLOSURE

The present invention relates to social media and entertainment. More specifically, the present invention is a mobile application designed to enhance the way users experience real-time streaming and live chat by leveraging dual camera functionality on a smartphone or a mobile device.

### BACKGROUND OF THE INVENTION

Real-time streaming and live chat have emerged as one of the most popular forms of entertainment and content consumption. It is an object of the present invention to enhance user experience by providing users with an application that leverages the dual camera functionality on a smartphone or a mobile device.

### SUMMARY OF THE INVENTION

The present invention is an innovative mobile application designed to improve how a user experiences real-time streaming and live chat over their smartphone or mobile device. The mobile application improves the user's experience by leveraging a smartphone's or a mobile device's dual cameras.

For real-time streaming, the mobile app can simultaneous stream live video from a front camera and a rear camera of the mobile device. This feature allows for unique perspectives, ideal for vlogging, live reporting, and interactive experiences where both the user and their surroundings are showcased in real time.

For live chat, the mobile app provides a live chat feature that allows viewers to interact with a streamer in real-time. This interaction between the streamer and the viewers fosters community engagement, making the streaming experience more immersive and dynamic.

Combining dual-camera streaming with live chat offers a powerful tool for content creators, influencers, and professionals who want to engage with their audience in a more interactive and personal way. Whether it's for virtual events, tutorials, or social interaction, the app enhances the user experience by providing multiple views and real-time communication.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 is a diagram displaying the modelling language incorporated by the present invention.

FIG. 2 is a flowchart displaying the functionality of the present invention.

FIG. 3 is a display of a user interface layout of the present invention.

FIG. 4 is a display of a user's profile layout of the present invention.

FIG. 5 is a display of a user's home page of the present invention.

FIG. 6 is a display of a user's explore page of the present invention.

All illustrations of the drawings are for the purpose of describing selected versions of the present invention and are not intended to limit the scope of the present invention.

### DETAILED DESCRIPTION

In the Summary of the Invention above, in this Detailed Description, in the Claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

The term “comprises”, and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Unless otherwise indicated, the drawings are intended to be read together with the specification and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. As used herein, the term “dorsal” refers to positions that are located near, on, or towards the upper or top side of a structure.

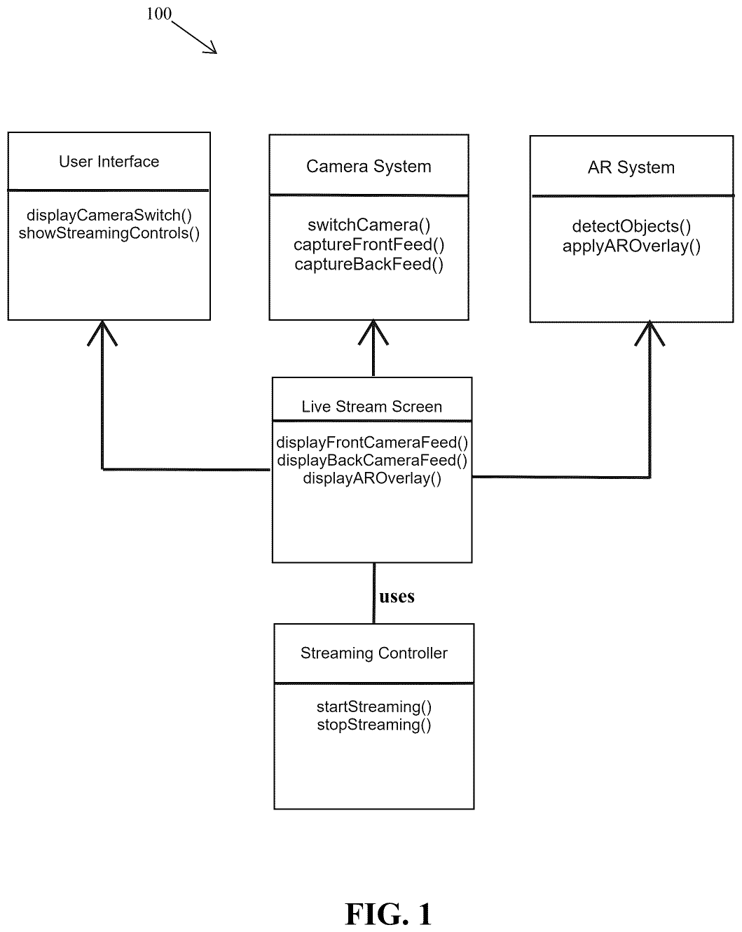

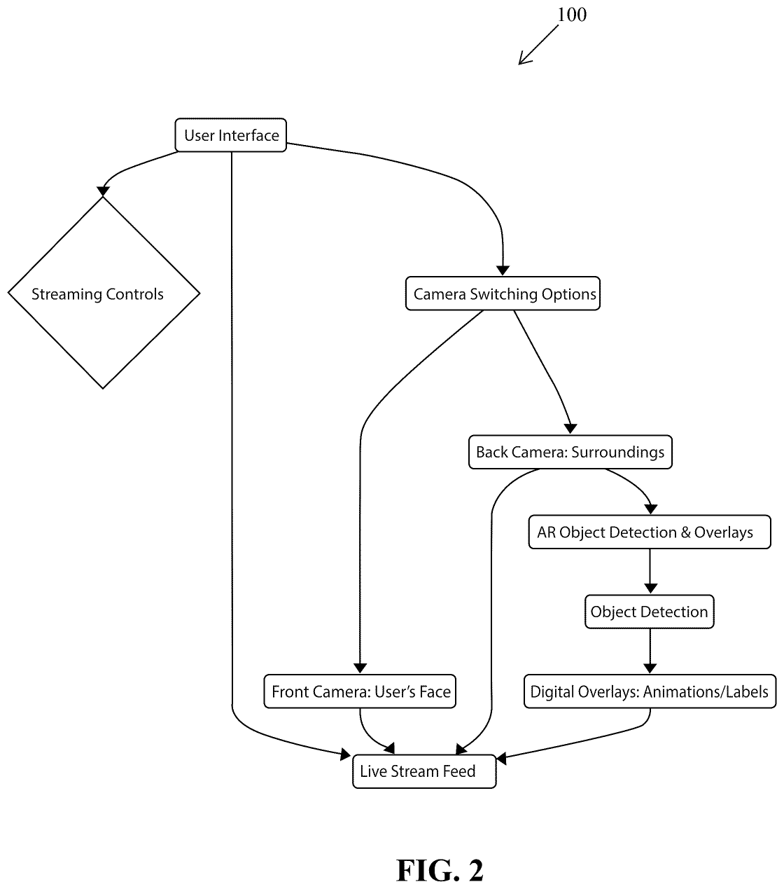

Referring now to FIG. 1 and FIG. 2, FIG. 1 is a diagram displaying a unified modelling language incorporated by the present invention an innovative mobile application 100. FIG. 2 is a flowchart displaying the functionality of the present invention an innovative mobile application 100. The process begins when a user opens the innovative mobile application 100 installed on their smartphone. The innovative mobile application 100 requests permission to access the smartphone's front camera, rear camera, and microphone. Once permission is granted, the innovative mobile application 100 simultaneously activates both the front camera and the rear camera using the smartphone's native camera APIs. A video stream from the front camera and the rear camera is initialized and prepared for real-time processing. The innovative mobile application 100 encodes the video streams from the front camera and the rear camera in real-time, ensuring that the video streams are optimized for streaming, wherein the video stream data is compressed to reduce bandwidth usage while maintaining quality. The two video streams are synchronized to ensure that there is no noticeable delay between the video stream of the front camera and the video stream of the rear camera, thus providing a cohesive viewing experience.

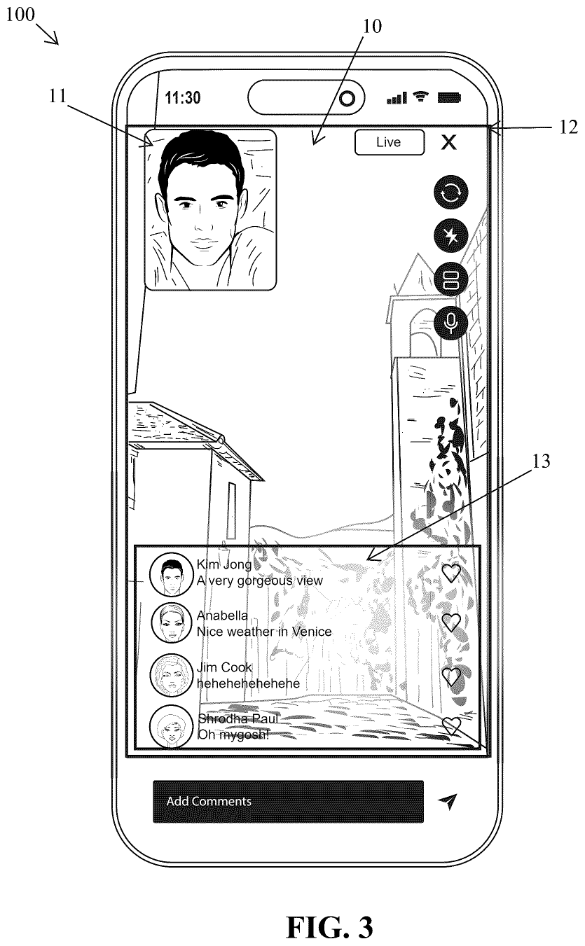

Referring now to FIG. 3, FIG. 3 is a display of a user interface layout 10 of the innovative mobile application 100 showing a real-time streaming and live chat functionality of the innovative mobile application 100. The real-time streaming consists of a video stream from a front camera 11 of a user's smartphone and a video stream from a rear camera 12 of the user's smartphone. A live chat window 13 is integrated into the user interface layout 10 simultaneously with the real-time stream.

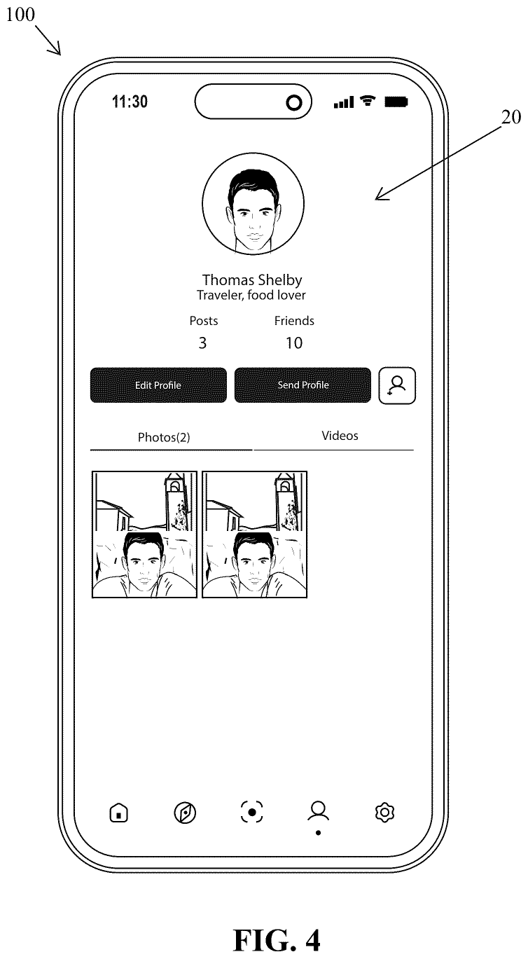

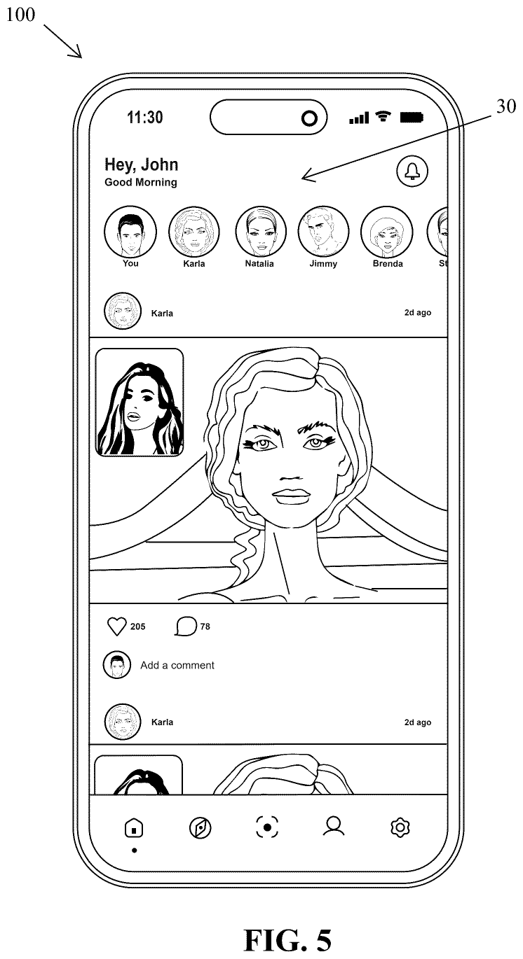

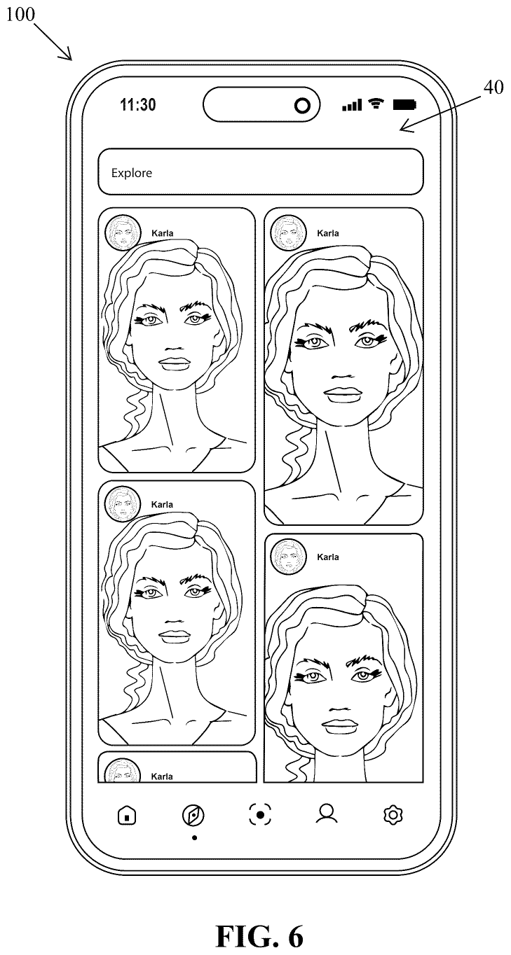

Referring now to FIGS. 4 5, and 6, FIG. 4 is a display of a user's profile page 20 of the present invention an innovative mobile application 100. FIG. 5 is a display of user's home page 30 of the present invention an innovative mobile application 100. FIG. 6 is a user's search page 40 of the present invention an innovative mobile application 100.

The present description includes one or more non-limiting embodiments of the present invention, an innovative mobile application (app) designed for a smartphone, the smartphone also known as a mobile device. The mobile app utilizes a front camera and a rear camera (dual cameras) of the mobile device to improve how a user experiences real-time streaming and live chat. The mobile app is comprised of a dual camera module, a real-time video processing engine, a streaming and broadcast module, and a live chat module. Additionally, the mobile app includes a user interface.

The dual camera module is a module responsible for accessing the front camera and the rear camera of the mobile device simultaneously. The mobile device has an Application Program Interface (API), for an Android mobile device this would be an Android Camera2 API and for an Apple mobile device this would be an iOS AVFoundation. The API allows a developer to access another application or platform within the mobile device. Here with the present invention, the mobile app uses the mobile device's native camera API to access both the front camera and the rear camera of the mobile device simultaneously, wherein the mobile app manages and synchronizes a video stream streaming from both the front camera and the rear camera. Using the API to access both the front camera and the rear camera simultaneously allows a user to broadcast video feeds from both cameras at the same time, wherein a user can control which camera is active, be it one camera or both cameras simultaneously. As such, a broadcast video feed can provide different perspectives in a single live stream based on the camera(s) in use.

Within the dual camera module is a camera switching control. The camera switching control allows a user to toggle between the front camera and the rear camera or use both cameras at the same time. This feature provides the user with flexibility in how they want to present their content, wherein the content can be displayed in a side-by-side mode, or in a Picture-in-Picture mode. With side-by-side mode, the video feed from the front camera is displayed next to the video feed from the rear camera. In Picture-in-Picture mode, one camera feed is displayed as a smaller overlay within a main video feed. For example, if the main video feed displayed is from the front camera, then the smaller overlay display is from the rear camera, and vice versa.

The real-time video processing engine handles real-time encoding and compression of a video stream. The real-time video processing engine processes a raw video feed from the front camera and a raw video feed from the rear camera. The real-time video processing engine compresses the two video feeds in real-time to ensure that the video stream is optimized for transmission over the internet.

The real-time video processing engine maintains video quality by its use of the available bandwidth. The real-time video processing engine supports adaptive bitrate streaming which dynamically adjusts the video quality based on network conditions.

Additionally, the real-time video processing engine synchronizes the video feeds from the front camera and the rear camera to provide a user with a seamless viewing experience. The real-time video processing engine allows the mobile app to process a video stream in real-time by ensuring that the front camera feed and the rear camera feed are synchronized and displayed without significant latency.

The streaming and broadcast module is responsible for broadcasting the processed video feeds to a selected streaming platform. The streaming and broadcast module integrates with platforms like YouTube Live or custom streaming servers, ensuring that the video is transmitted with minimal latency. Additionally, the streaming and broadcast module provides for adaptive streaming, wherein the streaming and broadcast module adjusts the video quality dynamically based on network conditions. Adjusting the video quality dynamically ensures that viewers receive the best possible stream quality without interruptions, even if their internet connection fluctuates.

The live chat module uses similar real-time communication to enable live chat. Similar real-time communication encompasses technologies and protocols designed to enable: instantaneous interaction which involves sending and receiving messages or data with minimal latency to create the impression of immediate communication; bidirectional or multidirectional communication which allows for data exchange between a single user (e.g., a streamer) and multiple participants (e.g., viewers) or among multiple participants simultaneously; synchronous data transmission, so as to ensure that messages, media, or signals are delivered and displayed in real-time or near real-time during an ongoing event.

Furthermore similar real-time communication may include, but is not limited to, communication protocols such as: WebRTC (Web Real-Time Communication), a technology that enables real-time peer-to-peer connections for live audio, video, and text communication; socket-based communication, systems using WebSockets or similar protocols to establish a persistent connection between clients and servers, facilitating continuous data exchange; RTMP (Real-Time Messaging Protocol), commonly used for transmitting audio, video, and data streams over the internet; MQTT (Message Queuing Telemetry Transport), a lightweight messaging protocol ideal for real-time communication in low-bandwidth environments.

As such, the integration of these established or analogous protocols to power the live chat module ensure that viewers can send messages to a streamer and other participants in real time; streamers can respond immediately, fostering a sense of community and engagement; and the communication remains synchronized with the dual-camera live stream, wherein chat messages are displayed alongside video streams.

The User Interface (UI) is a central control hub where all of a user interaction with the mobile app takes place. The UI displays video feeds from both the front camera and the rear camera, wherein the video feed configuration can be side-by-side or Picture-in-Picture. The video feeds are shown in a manner that maximizes viewer engagement and content visibility. The UI allows the user to: manage camera feeds between the front camera and rear camera; engage in a live chat with viewers; and monitor a video stream. The intuitive design of the UI allows users to switch between the front camera and rear cameras, interact with viewers effortlessly, and adjust video stream settings. Additionally, the UI provides for chat messages to be displayed alongside the video streams. A user can see incoming messages and respond in real-time, making the streaming experience more interactive.

For the present invention, a mobile application (app) that utilizes a front camera and a rear camera of a mobile device, wherein the mobile app allows for seamless dual-camera streaming and live chat functionality, the components work together as following:

Video streams from the front camera and the rear camera accessed by the dual camera module are fed directly into the UI for display. This synchronization ensures that what a user sees on their screen is an accurate representation of what the audience will view.

The real-time video processing engine processes the raw video feeds from the front camera and the rear camera. The real-time video processing engine encodes and compresses the video in real-time to ensure that the video streams are optimized for transmission over the internet. The real-time video processing engine works closely with the dual camera module to ensure that the video feeds are correctly formatted and with the UI to ensure the user's commands (like switching cameras) are executed smoothly. The processed video feed is then sent to the streaming and broadcasting module.

The streaming and broadcasting module is responsible for broadcasting the processed video feeds to a selected streaming platform. The streaming and broadcasting module integrates with platforms like YouTube Live or custom streaming servers, ensuring that the video feed is transmitted with minimal latency. The streaming and broadcasting module adjusts the video feed quality dynamically based on network conditions. This ensures that viewers receive the best possible stream quality without interruptions, even if their internet connection fluctuates.

The live chat module includes a chat interface that is integrated into the UI and works in tandem with the streaming and broadcasting module to facilitate real-time communication between a streamer and viewers. The live chat module integrates similar real-time communication protocols to enable live chat, wherein the live chat module uses WebSocket technology to ensure messages are delivered instantly during a livestream, fostering interactive engagement. Additionally, the live chat module handles features like message moderation and user authentication, ensuring that the chat remains a safe and engaging space.

What is claimed is:

1. A system that facilitates live video streaming and real-time interaction within a mobile application comprising:
a dual-camera module to simultaneous stream video from a front camera and a rear camera of a mobile device at the same present time;
an augmented reality module that detects and conveys digital information on real-world objects observed through the front camera and the rear camera of the mobile device; and
a live chat module enabling a real-time interaction during a live video streaming session between a user of the mobile device and viewers of the live video stream; the system utilizes the dual-camera module to access the video feed from the front camera and rear camera, wherein the augmented reality feature conveys digital information regarding real-world objects observed through the front camera and the rear camera, and the live chat module creates a live chat session during a simultaneous streaming of the front camera video feed and the rear camera video feed.

2. The system of claim 1, wherein access to the front camera of the mobile device, the rear camera of the mobile device, and a microphone of the mobile device is requested by the dual-camera module via the mobile device's native camera Application Program Interface.

3. The system of claim 2, wherein the request to access the microphone of the mobile device is granted to the dual-camera module allowing the microphone to record sounds accompanying a video recorded by the front camera and the rear camera.

4. The system of claim 3, wherein the request to access the front camera and the rear camera of the mobile device is granted to the dual-camera module, and the system simultaneously activates the front camera, the rear camera, and the microphone.

5. The system of claim 4, wherein a video stream from the front camera and a video stream from the rear camera is initialized and prepared for real-time processing.

6. The system of claim 5, wherein the video streams from the front camera and the rear camera are encoded in real-time, wherein a video stream data is compressed, reducing bandwidth usage.

7. The system of claim 6, wherein the video stream from the front camera is synchronized with the video stream from the rear camera such that there is no delay experienced when viewing the video streams of the front and rear camera at the same time.

8. The system of claim 7, wherein the synchronized live video stream is displayed on a screen of the mobile device.

9. The system of claim 8, wherein upon detecting a real-world object, the augmented reality module is activated and when requested to do so, reveals information regarding the real-world object to be displayed on a screen of the mobile device during the live video stream.

10. The system of claim 8, wherein during the live video stream the live chat module activates a live chat window to be incorporated into a display of the live video stream.

11. A system that facilitates live video streaming and real-time interaction within a mobile application comprising:
a dual-camera module to simultaneous stream video from a front camera and a rear camera of a mobile device at the same present time, wherein access to the front camera and the rear camera is requested by the dual-camera module via the mobile device's native camera Application Program Interface;
an augmented reality module that detects and conveys digital information on real-world objects observed through the front camera and the rear camera of the mobile device; and
a live chat module enabling a real-time interaction during a live video streaming session between a user of the mobile device and viewers of the live video stream; the system utilizes the dual-camera module to access a video feed from the front camera and a video feed from the rear camera, wherein the augmented reality module conveys digital information on objects observed through the front camera and the rear camera, and the live chat module creates a live chat session during a simultaneous streaming of the front camera video feed and the rear camera video feed.

12. The system of claim 11, wherein the request to access a microphone of the mobile device is granted to the dual-camera module allowing the microphone to record sounds accompanying a video recorded by the front camera and the rear camera.

13. The system of claim 12, wherein the request to access the front camera and the rear camera of the mobile device is granted to the dual-camera module, and the system simultaneously activates the front camera, the rear camera, and the microphone.

14. The system of claim 13, wherein a video stream from the front camera and a video stream from the rear camera is initialized and prepared for real-time processing.

15. The system of claim 14, wherein the video streams from the front camera and the rear camera are encoded in real-time, wherein a video stream data is compressed, reducing bandwidth usage.

16. The system of claim 15, wherein the video stream from the front camera is synchronized with the video stream from the rear camera such that there is no delay experienced when viewing the video streams of the front camera and the rear camera at the same time.

17. The system of claim 16, wherein the synchronized live video stream is displayed on a screen of the mobile device.

18. The system of claim 17, wherein upon detecting a real-world object, the augmented reality module is activated and when requested to do so, reveals information regarding the real-world object to be displayed on the screen of the mobile device during the live video stream.

19. The system of claim 17, wherein during the live video stream the live chat module activates a live chat window incorporated into a display of the live video stream.

20. The system of claim 19, wherein the live chat module includes moderation capabilities and interaction highlights.
